(19) United States
(12) Patent Application Publication
(10) Pub. No.: US 2012/0105384 A1
(43) Pub. Date: May 3, 2012

(54) DISPLAY WITH EMISSIVE AND REFLECTIVE LAYERS

(75) Inventor: Richard M. Clayton, Manorville, NY (US)

(73) Assignee: SYMBOL TECHNOLOGIES, INC., Schaumburg, IL (US)

(21) Appl. No.: 12/914,533

(22) Filed: Oct. 28, 2010

(51) Int. Cl. G09G 5/00; G09G 3/30

(52) U.S. Cl. 345/204; 345/76

(57) ABSTRACT

A display comprising includes a reflective panel 104 and a substantially transparent emissive panel 102. The emissive panel is aligned and positioned over the reflective panel 104. The emissive panel is operable to have an active pixel region 200 smaller than an active pixel region of the reflective panel 104. A controller 108 operable to provide first information for display on the reflective panel 104 and second information for display on the emissive panel 102, wherein the first and second information are coordinated to provide a single composite image to a user.

### FIELD OF THE DISCLOSURE

The present invention relates generally to electronic displays and more particularly to a display with emissive and reflective layers.

### BACKGROUND

Digital signs and electronic displays are increasingly using more sophisticated display technologies, including liquid crystal displays, electroluminescent diode displays, organic light emitting diode displays, e-ink, bistable displays, etc. Current displays can be either emissive (bright and easy to read, but with high power consumption) or reflective (limited visibility, limited update rate, but with low/zero static power consumption). Attempts have been made in a single display that tries to support both emissive and reflective operation by incorporating a backlight, but these attempts have been forced to make undesired power and legibility compromises. In particular, such displays are burdened most significantly by compromises in color legibility at low power and also reduced efficiency in the emissive mode. Most importantly, the whole display is either in emissive (backlight on) or reflective (backlight off) mode, wherein even having a small number emissive pixels of a bright color results in the power burden of backlighting the entire screen.

Different display technologies exhibit different advantages and disadvantages. For example, e-ink and other bistable technologies have very low power requirements but have some display performance limitations including dimness/legibility, the inability to display color (e-ink), or displaying colors that shift with viewing angle. LCD (liquid crystal display) and OLED (organic light emitting diode) displays have fewer limitations but have a comparatively high power consumption. There is no current display with a bistable power profile and the ability to display the occasional vibrant eye-catching color when needed.

Accordingly, there is a need for an electronic display with both emissive and reflective qualities that does not incur a significant power penalty.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram and edge view of an electronic display assembly, in accordance with some embodiments of the present invention.

FIGS. 2-3 present a view of two embodiments of an emissive panel, in accordance with the present invention.

FIGS. 4-6 present a view of the assembled operating display and independent views of the respective reflective and emissive panels, in accordance with one embodiment of the present invention.

FIGS. 7-9 present a view of the assembled operating display and independent views of the respective reflective and emissive panels, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides an electronic display with emissive and reflective layers or panels that does not incur a significant power penalty over a display with solely reflective properties. In particular, the present invention provides a display that has both a bistable panel and a transparent emissive panel (e.g. transparent OLED) which can be used separately to achieve the unique advantages of each technology with few compromises. For a unique capability, the two panels can also be used together so that the bistable display could display the bulk of the information with no power penalty and the emissive display that provide supplemental information in vibrant color (via the OLED panel) in order to catch the attention of a viewer. The power penalty for using the emissive display would only be for the few pixels that were used to display highlighted information.

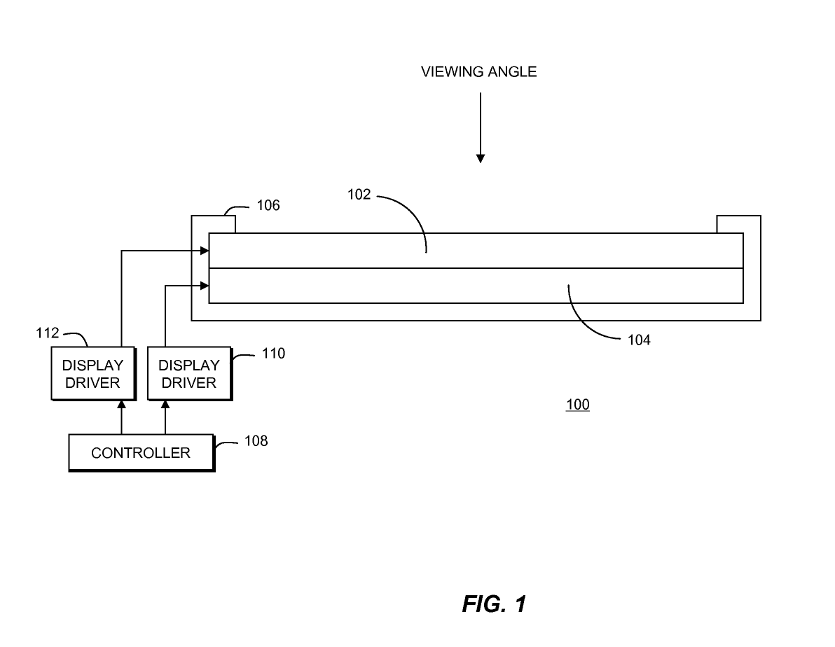

FIG. 1 shows an assembly adapted to support the inventive concepts of the embodiments of the present invention. Those skilled in the art will recognize that these figures do not depict all of the equipment necessary for the device and display to operate but only those components particularly relevant to the description of embodiments herein. For example, the display drivers can include power supplies, separate processors, controllers, interfaces, buffers, and the like, which are well-known. In addition, processing and controlling units are known to comprise basic components such as, but not limited to, microprocessors, microcontrollers, memory cache, application-specific integrated circuits (ASICs), and/or logic circuitry. Further, a user interface or programmer can be used to program the information to be displayed on the device, and this interface or programmer could be wired or wirelessly connected to the display 100, using technique known in the art.

Those skilled in the art are aware of the many design and development techniques available to configure the operation of a display. Therefore, the entities shown represent a known system that has been adapted, in accordance with the description herein, to implement various embodiments of the present invention. Furthermore, those skilled in the art will recognize that aspects of the present invention may be implemented in and across various physical components and none are necessarily limited to single platform implementations. It is within the contemplation of the invention that the operating requirements of the present invention can be implemented in software, firmware or hardware, with the function being implemented in a software processor (or a digital signal processor) being merely an option.

Referring to FIG. 1, a display 100 is shown that incorporates a reflective panel 104 and transparent emissive panel 102 assembled into a housing 106. A user that is viewing the display from a viewing angle will see information displayed on the reflective panel through the transparent emissive panel. Any information displayed on the emissive panel will be viewed as overlaying the information displayed on the reflective panel. Each panel is driven by a display driver 110, 112 that can be two separate units (as shown) or combined into a custom dual-display driver. A controller 108 directs the display drivers 110, 112 to display information on each panel in accordance with the present invention. It should be recognized that the controller and drivers could be incorporated into a single unit.

Of course, the display could be used with either the reflective panel operating or the emissive panel operating. Operating only a bistable (reflective) panel, such as an e-ink, and keeping the emissive panel off, will result in all the low power advantages of e-ink with only a slight reduction in reflected light due to the transparent panel, since there are no transparent panels that are 100% transparent. Operating only the emissive panel, such as an OLED, with the e-ink panel set to being either all black or all white depending on the desired effect, will result in the bright and colorful display advantages of OLED with significant power increase if a black e-ink background is chosen. In an alternative embodiment, it is possible to reverse the reflective and emissive layers in the case where the reflective layer switches from transparent to white (or some other color).

However, the present invention seeks to configure and operate both panels in a particular way to provide bright and colorful accents to the display without incurring a significant power penalty. In particular, the display is operated in an almost exclusively reflective bistable mode, but with a small number of emissive pixels lit up to attract the user's eye to important information. As a result, the dual-panel display offers a legibility and power consumption compromise that prior solutions cannot match. By having both panels visible to the user through the same display window, the user can remain largely ignorant of the underlying dual-panel operation.

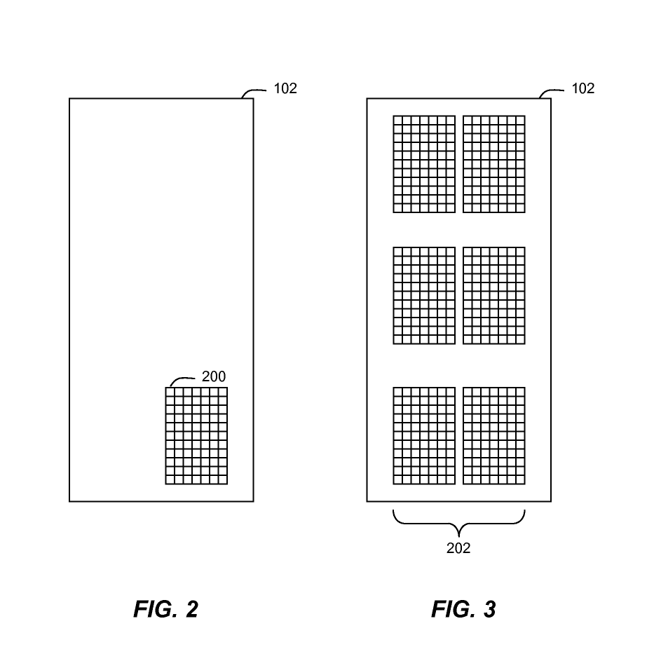

Referring to FIG. 2, the transparent emissive panel 102 is configured so that only a fixed small region 200 or portion of the panel is energized at one time. In effect, only the few pixels in this portion 200 will draw power, rather than having the entire panel energized as is required in the prior art. The information displayed by these few pixels supplements the information displayed on the reflective panel in a way to draw a viewer's eye to the display and the information displayed thereon. The reflective panel 104 is configured in a normal manner as is known in the art.

Referring to FIG. 3, the emissive panel 102 could include multiple portions 202 similar to the portion 200 of FIG. 2, with each portion having the ability to be driven separately from the other portions. Indeed, the multiple portions can effectively cover the entire panel 102, and divide the panel into separate regions that could be energized separately. As a result, any number of portions 202 could be energized to provide information. Having multiple portions 200 gives a display designer more flexibility in the placement of information on the emissive panel 102. However, it should be recognized that energizing all the portions 202 on a regular basis would defeat the advantage of the present invention. Therefore, it is envisioned that less than all of the portions (i.e. less than the entire panel), and preferable as few as possible of the portions, are energized to provide the power savings sought by the present invention while retaining the desired eye-catching quality for the display. In operation, the emissive panel will have an active pixel region smaller than an active pixel region of the reflective panel. It should also be recognized that the portions 202 could be of different shapes and sizes. As assembled, the emissive panel would be aligned and positioned over the reflective panel.

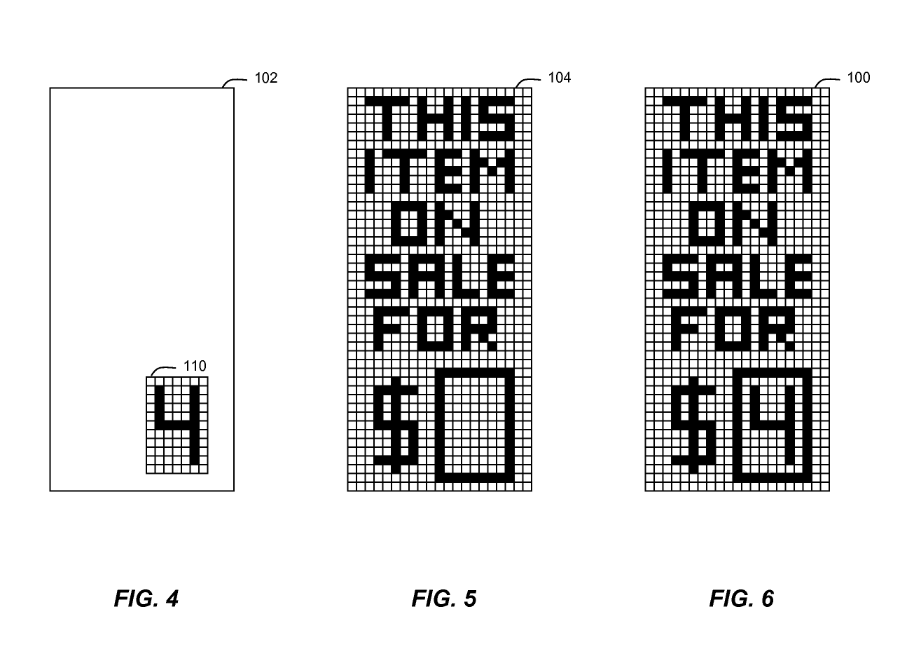

In one embodiment, referring to FIGS. 4-6, both panels 102, 104 can present different information in the assembled display 100. It is envisioned that this different information complements each other when viewed through both panels of the display 100 (FIG. 6). The information displayed by the two panels is coordinated by the controller to provide a single, seamless composite image to a user. In this example, the information on the emissive panel (FIG. 4) adds to information missing on the underlying reflective panel (FIG. 5). The controller 108 (of FIG. 1) splits the programmed information to be shown on the display into two parts. For example, the bistable panel 104 (FIG. 5) can present the information shown in black and white, leaving white pixels under the portion 110 of the emissive panel 102. The emissive panel 102 (FIG. 4) will activate pixels in the portion 110 to cover pixels of the reflective panel to present the number four in a bright color. As assembled (FIG. 6), the display will present a black-and-white sign with a brightly colored number four to catch a viewer's attention. Using white pixels on the reflective panel underlying the number four being displayed on the emissive panel can augment the brightness of the number four. Alternatively, using black pixels on the reflective panel underlying the number four being displayed on the emissive panel can provide a different effect in displaying the number four.

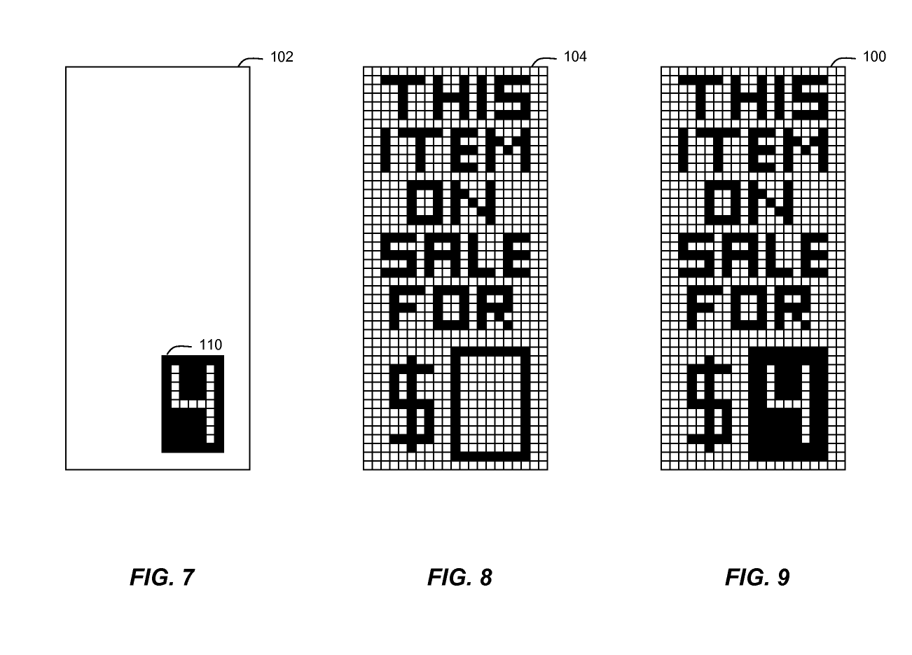

In another embodiment, referring to FIGS. 7-9, both panels 102, 104 can again present different information, which complements each other when viewed through both panels of the display 100 (FIG. 6). The information displayed by the two panels is coordinated by the controller to provide a single, seamless composite image to a user. In this example, the information on the emissive panel (FIG. 4) subtracts information that is then reflected by the underlying reflective panel (FIG. 5). The controller 108 (of FIG. 1) splits the programmed information to be shown on the display into two parts. For example, the bistable panel 104 (FIG. 5) can present the information shown in black and white, leaving white pixels under the portion 110 of the emissive panel 102. The emissive panel 102 (FIG. 4) will activate pixels in the portion 110 to uncover pixels of the reflective panel to present the number four in white, while the information on the emissive panel (FIG. 4) can highlight underlying information on the reflective panel in a bright color. As assembled (FIG. 6), the display will present a black-and-white sign with a brightly colored outlines of a white number four to catch a viewer's attention.

It is envisioned that different variations of the above scenarios can be used to achieve any desired effect. Moreover, a terminal or task specific device could use the emissive panel to provide video information within a portion of the display that can not be provided by the low-power reflective panel. In another example, the emissive panel could be used for short predetermined periods of time when color is required.

Advantageously, the present invention provides a good solution for a display that needs a long battery life while displaying largely static black-and-white information, but needs the ability to annotate the black-and-white information with small amounts of vibrant color in a power-efficient way.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized controllers of processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A display comprising:
a reflective panel;
a substantially transparent emissive panel, the emissive panel aligned and positioned over the reflective panel, the emissive panel operable to have an active pixel region smaller than an active pixel region of the reflective panel; and
a controller coupled to the reflective and emissive panels, the controller operable to provide first information for display on the reflective panel and second information for display on the emissive panel, wherein the first and second information are coordinated to provide a single composite image to a user.

2. The display of claim 1, wherein the second information on the emissive panel supplements a portion of the first information on the reflective panel.

3. The display of claim 1, wherein the second information on the emissive panel highlights a portion of the first information on the reflective panel.

4. The display of claim 1, wherein the second information is video information.

5. The display of claim 1, wherein the second information is presented for a predetermined time period.

6. The display of claim 1 wherein the reflective panel is a bistable display.

7. The display of claim 1, wherein the emissive panel is an organic light emitting diode display.

8. A display comprising:
a reflective panel being a bistable display;
a substantially transparent emissive panel being organic light emitting diode display, the emissive panel aligned and positioned over the reflective panel, the emissive panel operable to have an active pixel region smaller than an active pixel region of the reflective panel; and
a controller coupled to the reflective and emissive panels, the controller operable to provide first information for display on the reflective panel and second information for display on the emissive panel, wherein the first and second information are coordinated to provide a single composite image to a user.
